(19) United States
(12) Patent Application Publication
(10) Pub. No.: US 2007/0165165 A1
(43) Pub. Date: Jul. 19, 2007

(54) LIQUID CRYSTAL DISPLAY DEVICE

(76) Inventor: Kazuhiro JOTEN, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/621,299

(22) Filed: Jan. 9, 2007

(30) Foreign Application Priority Data
Jan. 17, 2006 (JP) 2006-008910

(51) Int. Cl. G02F 1/1335

(52) U.S. Cl. 349/119; 349/114

(57) ABSTRACT

A liquid crystal display device includes a first optical element and a second optical element. The first optical element is provided on one of outer surfaces of a liquid crystal display panel including homogeneously aligned liquid crystal molecules, and includes a first polarizer plate, a first retardation plate functioning as a ½ wavelength plate, and a second retardation plate in which nematic liquid crystal molecules are solidified in a state in which the nematic liquid crystal molecules are hybrid-aligned in a liquid crystal state in a normal direction. The second optical element is provided on the other outer surface of the liquid crystal display panel and includes a second polarizer plate, a third retardation plate functioning as a ½ wavelength plate, and a fourth retardation plate functioning as a ¼ wavelength plate. The fourth retardation plate has an Nz coefficient in a range of 1.5 to 2.0.

### CROSS-REFERENCE TO RELATED APPLICATIONS

This application is based upon and claims the benefit of priority from prior Japanese Patent Application No. 2006-008910, field Jan. 17, 2006, the entire contents of which are incorporated herein by reference.

### BACKGROUND OF THE INVENTION

1. Field of the Invention

The present invention relates generally to a liquid crystal display device, and more particularly to a transmissive or transflective liquid crystal display device including a liquid crystal layer which contains homogeneously aligned liquid crystal molecules.

2. Description of the Related Art

A technique has been proposed which realizes wide viewing angle characteristics by applying a viewing-angle compensation retardation film to a vertically aligned (VA) mode liquid crystal display device having excellent display characteristics in a frontal direction, like a twisted nematic (TN) mode liquid crystal display device (see, for instance, Jpn. Pat. Appln. KOKAI Publication No. 2005-099236).

In addition, a technique has been proposed for fabricating a biaxial birefringence film which is applicable to a liquid crystal display device of, e.g. an STN (Super Twisted Nematic) mode (see, for instance, Jpn. Pat. Appln. KOKAI Publication No. 2005-181451).

In recent years, there has been a demand for an improvement in display quality, such as a further increase in viewing angle and enhancement in contrast, in a liquid crystal display device which is configured such that a liquid crystal layer containing homogeneously aligned liquid crystal molecules is held between a pair of substrates.

### BRIEF SUMMARY OF THE INVENTION

The object of the present invention is to provide a liquid crystal display device with a good display quality.

According to a first aspect of the present invention, there is provided a liquid crystal display device comprising: a liquid crystal display panel which is configured such that a liquid crystal layer including homogeneously aligned liquid crystal molecules is held between a first substrate and a second substrate which are disposed to be opposed to each other; a first optical element which is provided on one of outer surfaces of the liquid crystal display panel and includes a first polarizer plate, a first retardation plate which is disposed between the first polarizer plate and the liquid crystal display panel and imparts a phase difference of ½ wavelength between light rays of a predetermined wavelength which pass through a fast axis and a slow axis of the first retardation plate, and a second retardation plate which is disposed between the first retardation plate and the liquid crystal display panel, imparts a phase difference of ¼ wavelength between light rays of a predetermined wavelength which pass through a fast axis and a slow axis of the second retardation plate, and is formed such that nematic liquid crystal molecules are solidified in a state in which the nematic liquid crystal molecules are hybrid-aligned in a normal direction; and a second optical element which is provided on the other outer surface of the liquid crystal display panel and includes a second polarizer plate, a third retardation plate which is disposed between the second polarizer plate and the liquid crystal display panel and imparts a phase difference of ½ wavelength between light rays of a predetermined wavelength which pass through a fast axis and a slow axis of the third retardation plate, and a fourth retardation plate which is disposed between the third retardation plate and the liquid crystal display panel and imparts a phase difference of ¼ wavelength between light rays of a predetermined wavelength which pass through a fast axis and a slow axis of the fourth retardation plate, wherein the fourth retardation plate has an Nz coefficient in a range of 1.5 to 2.0, which is defined by Nz=(nx−nz)/(nx−ny), where nx and ny are refractive indices in mutually perpendicular directions in a plane of the fourth retardation plate, and nz is a refractive index in a normal direction of the fourth retardation plate.

According to a second aspect of the present invention, there is provided a liquid crystal display device comprising: a liquid crystal display panel which is configured such that a liquid crystal layer including homogeneously aligned liquid crystal molecules is held between a first substrate and a second substrate which are disposed to be opposed to each other; a first optical element which is provided on one of outer surfaces of the liquid crystal display panel and includes a first polarizer plate, a first retardation plate which is disposed between the first polarizer plate and the liquid crystal display panel and imparts a phase difference of ½ wavelength between light rays of a predetermined wavelength which pass through a fast axis and a slow axis of the first retardation plate, and a second retardation plate which is disposed between the first retardation plate and the liquid crystal display panel, imparts a phase difference of ¼ wavelength between light rays of a predetermined wavelength which pass through a fast axis and a slow axis of the second retardation plate, and is formed such that nematic liquid crystal molecules are solidified in a state in which the nematic liquid crystal molecules are hybrid-aligned in a normal direction; and a second optical element which is provided on the other outer surface of the liquid crystal display panel and includes a second polarizer plate, a third retardation plate which is disposed between the second polarizer plate and the liquid crystal display panel and imparts a phase difference of ½ wavelength between light rays of a predetermined wavelength which pass through a fast axis and a slow axis of the third retardation plate, a uniaxial fourth retardation plate which is disposed between the third retardation plate and the liquid crystal display panel and imparts a phase difference of ¼ wavelength between light rays of a predetermined wavelength which pass through a fast axis and a slow axis of the fourth retardation plate, and a fifth retardation plate which is disposed between the fourth retardation plate and the liquid crystal display panel, wherein the fifth retardation plate has a refractive index anisotropy of nx=ny>nz, where nx and ny are refractive indices in mutually perpendicular directions in a plane of the fifth retardation plate RF5, and nz is a refractive index in a normal direction of the fifth retardation plate.

The present invention can provide a liquid crystal display device with a good display quality.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display device according to an embodiment of the present invention;

FIG. 2 schematically shows a cross-sectional structure of the liquid crystal display device shown in FIG. 1;

FIG. 3 schematically shows the structures of a first optical element and a second optical element of a liquid crystal display device according to a first embodiment of the invention;

FIG. 4A is a characteristic diagram of the viewing angle dependency of a contrast ratio in a liquid crystal display device to which a fourth retardation plate with an Nz coefficient of 0.5 is applied;

FIG. 4B is a characteristic diagram of the viewing angle dependency of a contrast ratio in a liquid crystal display device to which a fourth retardation plate with an Nz coefficient of 1.0 is applied;

FIG. 4C is a characteristic diagram of the viewing angle dependency of a contrast ratio in a liquid crystal display device to which a fourth retardation plate with an Nz coefficient of 1.5 is applied;

FIG. 4D is a characteristic diagram of the viewing angle dependency of a contrast ratio in a liquid crystal display device to which a fourth retardation plate with an Nz coefficient of 2.0 is applied;

FIG. 4E is a characteristic diagram of the viewing angle dependency of a contrast ratio in a liquid crystal display device to which a fourth retardation plate with an Nz coefficient of 2.5 is applied;

FIG. 5A is a characteristic diagram of the viewing angle dependency of a contrast ratio in a liquid crystal display device to which a second retardation plate with a mean tilt angle of 17.8° is applied;

FIG. 5B is a characteristic diagram of the viewing angle dependency of a contrast ratio in a liquid crystal display device to which a second retardation plate with a mean tilt angle of 28.2° is applied;

FIG. 5C is a characteristic diagram of the viewing angle dependency of a contrast ratio in a liquid crystal display device to which a second retardation plate with a mean tilt angle of 37.3° is applied;

FIG. SD is a characteristic diagram of the viewing angle dependency of a contrast ratio in a liquid crystal display device to which a second retardation plate with a mean tilt angle of 44.5° is applied;

FIG. 6 schematically shows the structures of a first optical element and a second optical element of a liquid crystal display device according to a second embodiment of the invention;

FIG. 7 is a view for explaining the structures of Example 1 and a comparative example;

FIG. 8 is a view for explaining the directions of slow axes of retardation plates and the directions of absorption axes of polarizer plates in the structure of Example 1; and

FIG. 9 schematically shows the structure of an optical element which is applicable to the first optical element and the second optical element.

### DETAILED DESCRIPTION OF THE INVENTION

A liquid crystal display device according to an embodiment of the present invention will now be described with reference to the accompanying drawings. In this embodiment, a transflective liquid crystal display device is exemplified, wherein each of pixels includes a reflective part which displays an image by making use of ambient light, and a transmissive part which displays an image by making use of backlight. The present invention, however, is not limited to this example. The invention is applicable to various types of liquid crystal display devices such as a transmissive liquid crystal display device in which each pixel includes a transmissive part alone, and a liquid crystal display device in which some pixels of a display region include reflective parts and other pixels include transmissive parts.

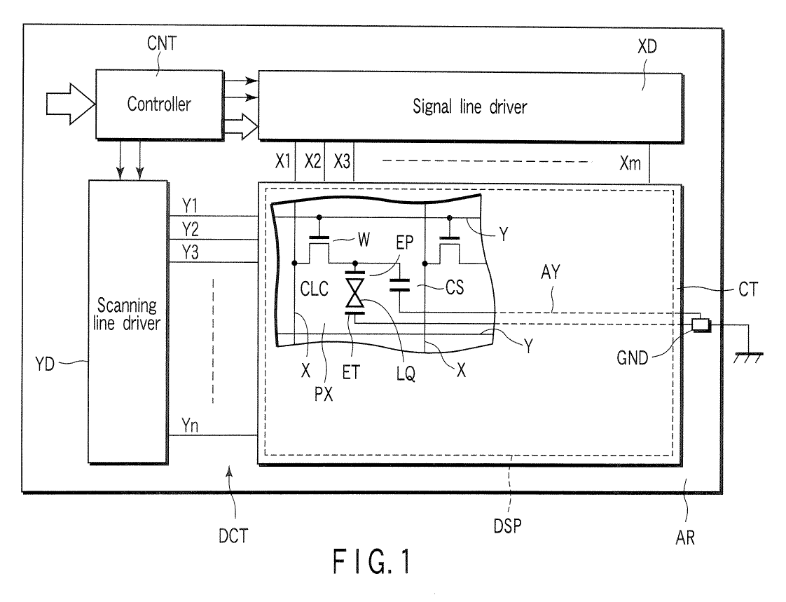

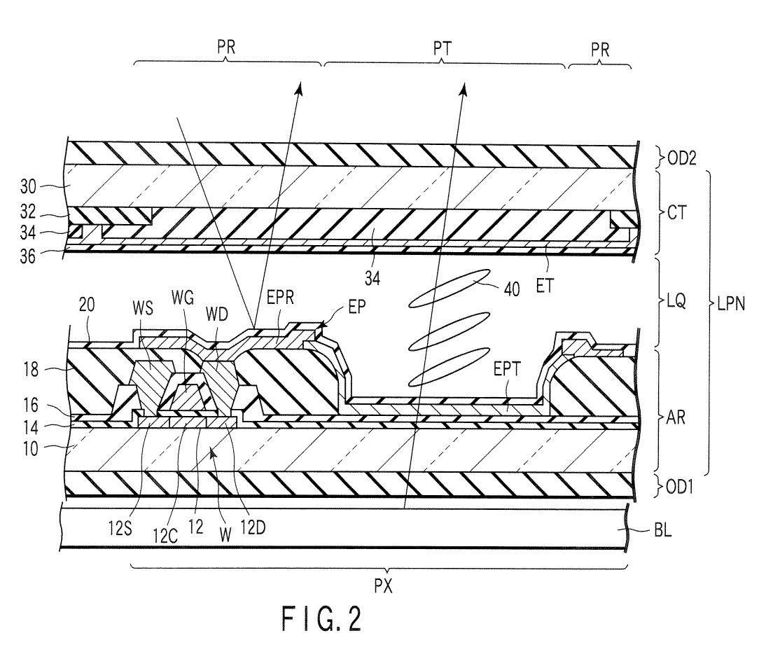

As is shown in FIG. 1 and FIG. 2, the liquid crystal display device is an active-matrix-type transflective color liquid crystal device, which includes a liquid crystal display panel LPN. The liquid crystal display panel LPN is configured to include an array substrate (first substrate) AR, a counter-substrate (second substrate) CT which is disposed to be opposed to the array substrate AR, and a liquid crystal layer LQ which is held between the array substrate AR and the counter-substrate CT.

In addition, the liquid crystal display device includes a first optical element OD1 which is provided on one of outer surfaces of the liquid crystal display panel LPN (i.e. an outer surface of the array substrate AR, which is opposed to the other outer surface thereof facing the liquid crystal layer LQ), and a second optical element OD2 which is provided on the other outer surface of the liquid crystal display panel LPN (i.e. an outer surface of the counter-substrate CT, which is opposed to the other outer surface thereof facing the liquid crystal layer LQ). Further, the liquid crystal display device, which is configured to include transmissive parts, includes a backlight unit BL which illuminates the liquid crystal display panel LPN from the first optical element OD1 side.

The liquid crystal display device includes a plurality of pixels PX which are arrayed in a matrix of m×n in a display region DSP that displays an image. Each pixel PX includes a reflective part PR which displays an image by selectively reflecting ambient light (“reflective display”), and a transmissive part PT which displays an image by selectively passing backlight from the backlight unit BL (“transmissive display”).

The array substrate AR is formed by using an insulating substrate 10 having light transmissivity, such as a glass plate or a quartz plate. Specifically, the array substrate AR includes, in the display region DSP, an (m×n) number of pixel electrodes EP which are disposed in the respective pixels, an n-number of scanning lines Y (Y1 to Yn) which are formed in the row direction of the pixel electrodes EP, an m-number of signal lines X (X1 to Xm) which are formed in the column direction of the pixel electrodes EP, an (m×n) number of switching elements W which are disposed in regions including intersections between the scanning lines Y and signal lines X in the respective pixels PX, and storage capacitance lines AY which are capacitive-coupled to the pixel electrodes EP so as to constitute storage capacitances CS in parallel with liquid crystal capacitances CLC.

Further, in a driving circuit region DCT in the vicinity of the display region DSP, the array substrate AR includes at least a part of a scanning line driver YD which is connected to the n-number of scanning lines Y and at least a part of a signal line driver XD which is connected to the m-number of signal lines X. The scanning line driver YD successively supplies scanning signals (driving signals) to the n-number of scanning lines Y on the basis of the control by a controller CNT. The signal line driver XD supplies, under the control of the controller CNT, video signals (driving signals) to the m-number of signal lines X at a timing when the switching elements W of each row are turned on by the scanning signal. Thereby, the pixel electrodes EP in each row are set at pixel potentials corresponding to the video signals that are supplied via the associated switching elements W.

Each of the switching elements W is, for instance, an n-channel thin-film transistor, and includes a semiconductor layer 12 which is disposed on the insulating substrate 10. The semiconductor layer 12 can be formed by using, e.g. polysilicon or amorphous silicon. In this embodiment, the semiconductor layer 12 is formed of polysilicon. The semiconductor layer 12 includes a source region 12S and a drain region 12D, between which a channel region 12C is interposed. The semiconductor layer 12 is covered with a gate insulation film 14.

A gate electrode WG of the switching element W is connected to one associated scanning line Y (or formed integral with the scanning line Y). The gate electrode WG, together with the scanning line Y and storage capacitance line AY, is disposed on the gate insulation film 14. The gate electrode WG, scanning line W and storage capacitance line AY are covered with an interlayer insulation film 16.

A source electrode WS and a drain electrode WD of the switching element W are disposed on the interlayer insulation film 16 on both sides of the gate electrode WG. The source electrode WS is connected to one associated signal line X (or formed integral with the signal line X) and is put in contact with the source region 12S of the semiconductor layer 12. The drain electrode WD is connected to one associated pixel electrode EP (or formed integral with the pixel electrode EP) and is put in contact with the drain region 12D of the semiconductor layer 12. The source electrode WS, drain electrode WD and signal line X are covered with an organic insulation film 18.

The pixel electrode EP includes a reflective electrode EPR which is provided in association with the reflective part PR, and a transmissive electrode EPT which is provided in association with the transmissive part PT. The reflective electrode EPR is disposed on the organic insulation film 18 and is electrically connected to the drain electrode WD. The reflective electrode EPR is formed of a light-reflective electrically conductive material such as aluminum. The transmissive electrode EPT is disposed on the interlayer insulation film 16 and is electrically connected to the reflective electrode EPR. The transmissive electrode EPT is formed of a light-transmissive electrically conductive material such as indium tin oxide (ITO). The pixel electrode EP, which is disposed in each associated pixel PX, is covered with an alignment film 20.

The counter-substrate CT is formed by using a light-transmissive insulating substrate 30 such as a glass plate or a quartz plate. Specifically, the counter-substrate CT includes, in the display region DSP, a black matrix 32 which partitions the pixels PX, a color filter 34 which is surrounded by the black matrix 32 and is disposed in association with each pixel, and a counter-electrode ET.

The black matrix 32 is disposed to be opposed to wiring lines, such as scanning lines Y and signal lines X, which are provided on the array substrate AR. The color filter 34 is formed of color resins of a plurality of colors, for example, the three primary colors of red, blue and green. The red color resin, blue color resin and green color resin are disposed in association with a red pixel, a blue pixel and a green pixel, respectively.

The color filter 34 may be formed to have different optical densities between the reflective part PR and transmissive part PT. Specifically, in the reflective part PR, ambient light which contributes to display passes through the color filter 34 twice. In the transmissive part PT, backlight which contributes to display passes through the color filter 34 only once. Thus, in order to match hues between the reflective part PR and transmissive part PT, it is desirable to set the optical density of the color resin, which is disposed in the reflective part PR, at about half the optical density of the color resin which is disposed in the transmissive part PT.

The counter-electrode ET is disposed to be opposed to the pixel electrodes EP of the plural pixels PX. The counter-electrode ET is formed of a light-transmissive metal film of, e.g. indium tin oxide (ITO). The counter-electrode ET is covered with an alignment film 36.

When the counter-substrate CT and array substrate AR are disposed such that when their alignment films 20 and 36 are opposed, a predetermined gap is provided by spacers (not shown) which are disposed between the alignment films 20 and 36. At this time, the gap formed in the reflective part PR is about half the part formed in the transmissive part PT.

The liquid crystal layer LQ is composed of a liquid crystal composition including liquid crystal molecules 40, which is sealed in the gap between the alignment film 20 of the array substrate AR and the alignment film 36 of the counter-substrate CT. In this embodiment, the liquid crystal layer LQ includes liquid crystal molecules 40 with a twist angle of 0 deg. (homogeneous alignment). The twist angle of the liquid crystal molecules is controllable by a rubbing treatment which is performed on the alignment film 20 and alignment film 36.

### First Embodiment

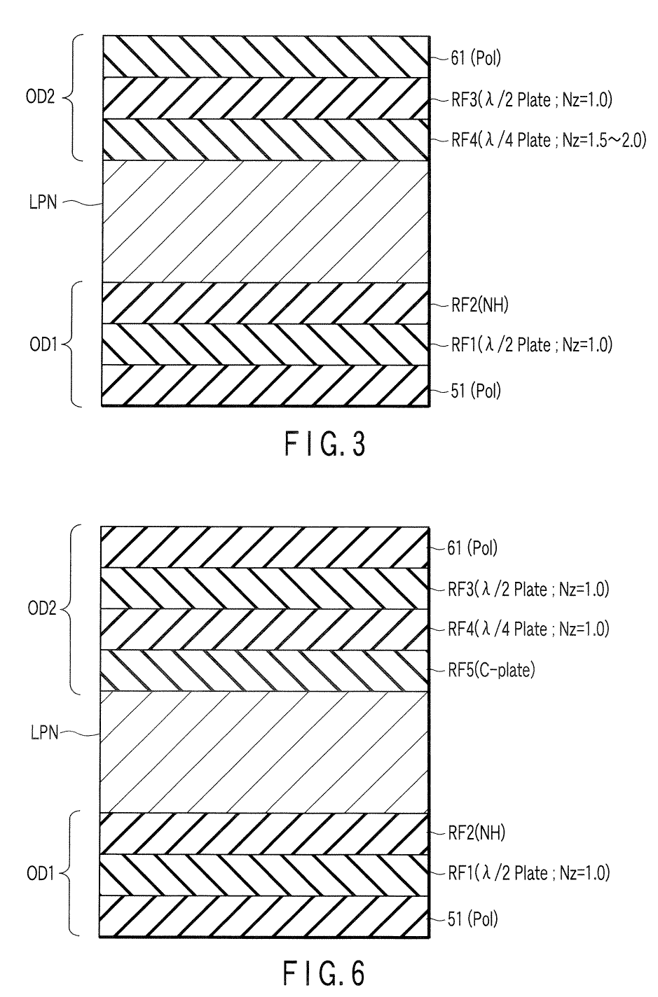

In a liquid crystal display device according to a first embodiment of the invention, as shown in FIG. 3, the first optical element OD1 and second optical element OD2 control the polarization state of light that passes therethrough. Specifically, the first optical element OD1 controls the polarization state of light passing through the first optical element OD1 so that elliptically polarized or circularly polarized light may be incident on the liquid crystal layer LQ. Thus, the polarization state of backlight, which is incident on the first optical element OD1, is converted to a predetermined polarization state while the backlight is passing through the first optical element OD1. The backlight, which emerges from the first optical element OD1, enters the liquid crystal layer LQ while keeping the predetermined polarization state.

Similarly, the second optical element OD2 controls the polarization state of light passing through the second optical element OD2 so that elliptically polarized or circularly polarized light may be incident on the liquid crystal layer LQ. Thus, the polarization state of ambient light, which is incident on the second optical element OD2, is converted to a predetermined polarization state while the ambient light is passing through the second optical element OD2. The ambient light, which emerges from the second optical element OD2, enters the liquid crystal layer LQ while keeping the predetermined polarization state.

The first optical element OD1 includes a first polarizer plate 51, a first retardation plate RF1 which is disposed between the first polarizer plate 51 and the liquid crystal display panel LPN, and a second retardation plate RF2 which is disposed between the first retardation plate RF1 and the liquid crystal display panel LPN.

The second optical element OD2 includes a second polarizer plate 61, a third retardation plate RF3 which is disposed between the second polarizer plate 61 and the liquid crystal display panel LPN, and a fourth retardation plate RF4 which is disposed between the third retardation plate RF3 and the liquid crystal display panel LPN.

Each of the first polarizer plate 51 and second polarizer plate 61 used in this embodiment has an absorption axis and a transmission axis which intersect at right angles in a plane perpendicular to the direction of travel of light. The polarizer plate extracts light having a unidirectional oscillation plane parallel to the transmission axis, i.e. linearly polarized light, from the light having oscillation planes in random directions.

The second retardation plate RF2 used in this embodiment is a liquid crystal film in which nematic liquid crystal molecules having an optically positive uniaxial refractive index anisotropy are solidified in a state in which the liquid crystal molecules are hybrid-aligned along the normal direction in the liquid crystal phase. An NH film (manufactured by Nippon Oil Corporation) is applicable as the second retardation plate RF2. This liquid crystal film corresponds to a retardation plate having a viewing angle increasing function.

Each of the first retardation plate RF1 and second retardation plate RF2 included in the first optical element OD1 and each of the third retardation plate RF3 and fourth retardation plate RF4 included in the second optical element OD2 has a slow axis and a fast axis which intersect at right angles. In discussing birefringence, the slow axis corresponds to an axis in which a refractive index is relatively large, and the fast axis corresponds to an axis in which a refractive index is relatively small. It is assumed that the slow axis agrees with an oscillation plane of extraordinary rays, and that the fast axis agrees with an oscillation plane of ordinary rays. When the refractive index of ordinary rays and the refractive index of extraordinary rays are no and ne, respectively, and the thickness of the retardation plate or the liquid crystal layer extending in the direction of travel of rays is d, a phase difference Δn·d (nm) of the retardation plate or the liquid crystal layer is defined by (ne·d−no·d) (i.e. Δn=ne−no).

Each of the first retardation plate RF1 and third retardation plate RF3 is a so-called ½ wavelength plate which imparts a phase difference of ½ wavelength between light rays of a predetermined wavelength which pass through the fast axis and slow axis. The fourth retardation plate RF4 is a so-called ¼ wavelength plate which imparts a phase difference of ¼ wavelength between light rays of a predetermined wavelength which pass through the fast axis and slow axis. Aside from the above-described viewing angle increasing function, the second retardation plate RF2 has a slow axis in the direction of alignment of liquid crystal molecules and a fast axis in a direction perpendicular to the slow axis and functions as a ¼ wavelength plate which imparts a phase difference of ¼ wavelength between light rays of a predetermined wavelength which pass through the fast axis and slow axis.

The combination of the first retardation plate RF1 and second retardation plate RF2 is disposed such that the slow axis of each of these retardation plates forms, in the plane thereof, a predetermined angle (acute angle) relative to the absorption axis (or transmission axis) of the first polarizer plate 51. Thereby, the combination of the first retardation plate RF1 and second retardation plate RF2 functions to convert the linearly polarized light, which emerges from the first polarizer plate 51, to elliptically polarized light or circularly polarized light having a predetermined ellipticity (=amplitude in minor axis/amplitude in major axis).

Similarly, the combination of the third retardation plate RF3 and fourth retardation plate RF4 is disposed such that the slow axis of each of these retardation plates forms, in the plane thereof, a predetermined angle (acute angle) relative to the absorption axis (or transmission axis) of the second polarizer plate 61. Thereby, the combination of the third retardation plate RF3 and fourth retardation plate RF4 functions to convert the linearly polarized light, which emerges from the second polarizer plate 61, to elliptically polarized light or circularly polarized light having a predetermined ellipticity.

In general, a birefringent material, of which the retardation plate is formed, has such characteristics that the refractive index no for ordinary rays and the refractive index ne for extraordinary rays depend on the wavelength of light. Thus, the retardation value Δn·d of the retardation plate depends on the wavelength of passing light. With the above-described structure, at least two kinds of retardation plates (½ wavelength plate and ¼ wavelength plate) are combined, and the wavelength dependency of the retardation value of the retardation plate is relaxed. Thereby, in the entire range of wavelengths that are used for color display, a predetermined retardation is imparted and a desired polarization state is obtained.

Next, a study is made on the range of an optimal Nz coefficient of the fourth retardation plate RF4 which is opposed to the second retardation plate RF2 with the liquid crystal panel LPN interposed in the above-described structure of the first embodiment. The Nz coefficient is defined as a value that is given as Nz=(nx−nz)/(nx−ny), where nx and ny are refractive indices in mutually perpendicular directions in the plane of the retardation plate, and nz is a refractive index in the normal direction of the retardation plate.

In this study, it is assumed that the Nz coefficient of each of the first retardation plate RF1 and third retardation plate RF3 is 1.0. As regards the second retardation plate RF2, an in-plane retardation Ro, which is defined by Ro=(nx−ny)×d (d is a thickness of the second retardation plate in the normal direction), is set at 110 nm, and a mean tilt angle of liquid crystal molecules in the second retardation plate RF2 is set at 28°.

For the purpose of convenience, an X axis and a Y axis, which are perpendicular to each other, are defined in a plane parallel to the major surface of the array substrate AR (or counter-substrate CT) in the case where the liquid crystal display device is observed from the counter-substrate side. A Z axis is defined as a normal direction to this plane. The term “in-plane” refers to “in the plane defined by the X axis and Y axis”. It is assumed that the X axis corresponds to the horizontal direction of the screen (e.g. the row direction in the display region). It is assumed that the Y axis corresponds to the vertical direction of the screen (e.g. the column direction in the display region). It is assumed that a direction (0° azimuth) on the positive (+) side of the X axis corresponds to the right side of the screen, and a direction (180° azimuth) on the negative (−) side of the X axis corresponds to the left side of the screen. Further, it is assumed that a direction (90° azimuth) on the positive (+) side of the Y axis corresponds to the upper side of the screen, and a direction (270° azimuth) on the negative (−) side of the Y axis corresponds to the lower side of the screen.

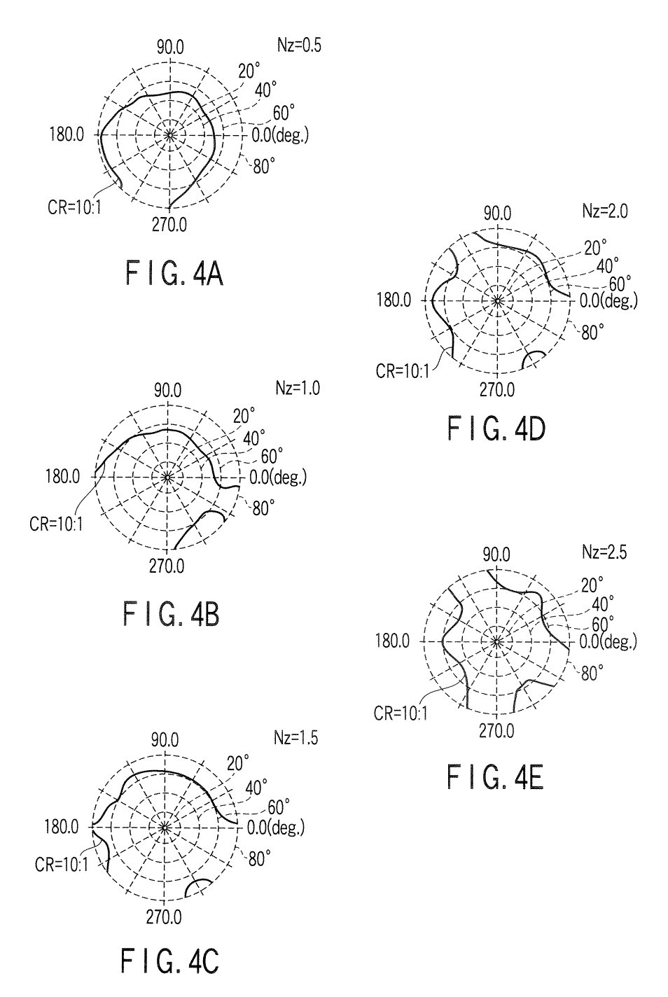

FIG. 4A to FIG. 4E show simulation results of the viewing angle dependency of the contrast ratio (CR). FIG. 4A corresponds to the case where the Nz coefficient of the fourth retardation plate RF4 is 0.5, FIG. 4B corresponds to the case where the Nz coefficient of the fourth retardation plate RF4 is 1.0, FIG. 4C corresponds to the case where the Nz coefficient of the fourth retardation plate RF4 is 1.5, FIG. 4D corresponds to the case where the Nz coefficient of the fourth retardation plate RF4 is 2.0, and FIG. 4E corresponds to the case where the Nz coefficient of the fourth retardation plate RF4 is 2.5.

In FIG. 4A to FIG. 4E, the center corresponds to the normal direction of the liquid crystal display panel. Concentric circles defined about the normal direction indicate tilt angles (viewing angles) to the normal direction, and correspond to 20°, 40°, 60° and 80°, respectively. The characteristic diagrams of FIG. 4A to FIG. 4E were obtained by connecting regions corresponding to a contrast ratio of 10:1 in all directions.

As shown in FIG. 4A, in the case where the fourth retardation plate RF4 with the Nz coefficient of 0.5 is applied, it was confirmed that the contrast ratio decreased in accordance with an increase of the viewing angle from the normal direction, in particular, on the right side and upper side of the screen. In addition, as shown in FIG. 4B, in the case where the fourth retardation plate RF4 with the Nz coefficient of 1.0 is applied, it was confirmed that the contrast ratio decreased in accordance with an increase of the viewing angle from the normal direction, in particular, on the right side and upper side of the screen, and the contrast ratio of 10:1 was obtained in the range of viewing angles of less than 60°.

On the other hand, as shown in FIG. 4C and FIG. 4D, in the case where the fourth retardation plate RF4 with the Nz coefficient of 1.5 to 2.0 is applied, it was confirmed that the contrast ratio of 10:1 was obtained in the range of viewing angles of 60° or more in all the right-and-left and up-and-down directions of the screen, and a sufficiently wide viewing angle was obtained. As shown in FIG. 4E, in the case where the fourth retardation plate RF4 with the Nz coefficient of 2.5 is applied, it was confirmed that the contrast ratio decreased in accordance with an increase of the viewing angle from the normal direction, in particular, on the left side of the screen, and the contrast ratio of 10:1 was obtained in the range of viewing angles of less than 60°. In oblique directions (e.g. 45°-225° azimuth, and 135°-315° azimuth), the contrast sharply decreased and the display quality considerably deteriorated.

Based on the above study, in the first embodiment with the above-described structure, it was confirmed that the range of optimal Nz coefficients of the fourth retardation plate RF4, which is disposed to be opposed to the second retardation plate RF2 with the liquid crystal display panel LPN interposed, is 1.5 to 2.0.

Next, as regards the structure of the first embodiment, a study is made on the range of optimal mean tilt angles of liquid crystal molecules in the second retardation plate RF2. The mean tilt angle P is defined as an angle of a depth-directional major refractive index nz to the normal direction. In a simple method of definition, the mean tilt angle β is defined as a value that is given as [(high tilt angle+low tilt angle)/2+low tilt angle]. In the above-described second retardation plate RF2, for example, the “high tilt angle” corresponds to a tilt angle (an inclination to the major surface of the array substrate) of those of hybrid-aligned liquid crystal molecules, which are raised with a maximum inclination to the major surface of the array substrate. The “low tilt angle” corresponds to a tilt angle of those of hybrid-aligned liquid crystal molecules, which are raised with a minimum inclination to the major surface of the array substrate.

In this study, the Nz coefficient of each of the first retardation plate RF1 and third retardation plate RF3 is set at 1.0, and the Nz coefficient of the fourth retardation plate RF4 is set at 1.8. In addition, the in-plane retardation Ro of the second retardation plate RF2 is set at 110 nm.

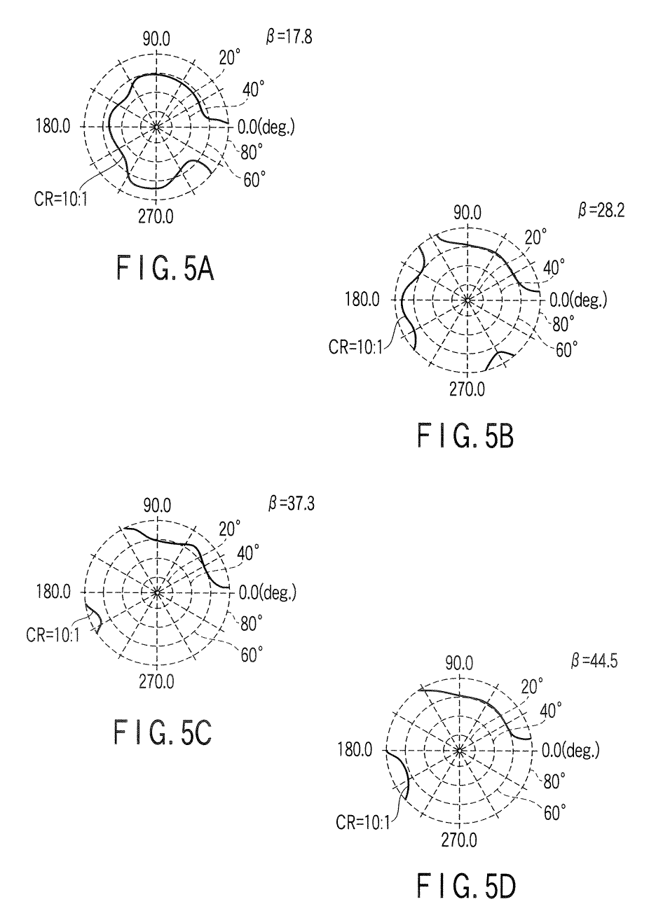

FIG. 5A to FIG. 5D show simulation results of the viewing angle dependency of the contrast ratio. FIG. 5A corresponds to the case where the mean tilt angle β is 17.8°, FIG. 5B corresponds to the case where the mean tilt angle β is 28.2°, FIG. 5C corresponds to the case where the mean tilt angle β is 37.3°, and FIG. 5D corresponds to the case where the mean tilt angle β is 44.5°.

The characteristic diagrams of FIG. 5A to FIG. 5D were obtained by connecting regions corresponding to a contrast ratio of 10:1 in all directions.

As shown in FIG. 5A, in the case where the second retardation plate RF2 with the mean tilt angle β of 17.8° is applied, it was confirmed that the contrast ratio decreased in accordance with an increase of the viewing angle from the normal direction, in particular, on the left side and upper side of the screen. On the other hand, as shown in FIG. 5B to FIG. 5D, in the case where the second retardation plate RF2 with the mean tilt angle β of more than 28° is applied, it was confirmed that the contrast ratio of 10:1 was obtained in the range of viewing angles of 60° or more in all the right-and-left and up-and-down directions of the screen, and a sufficiently wide viewing angle was obtained.

Based on the above study, in the first embodiment with the above-described structure, it was confirmed that the range of optimal mean tilt angles of liquid crystal molecules in the second retardation plate RF2 is more than 28°. Specifically, if the above-described structure of the first embodiment is combined with the second retardation plate RF2 having the mean tilt angle of liquid crystal molecules which is greater than 28°, the viewing angle can be increased not only in the up-and-down and right-and-left directions of the screen, but also in oblique directions.

According to the structure of the first embodiment, there is provided a liquid crystal display device which can improve the contrast, increase the viewing angle, and have a good display quality.

### Second Embodiment

In a liquid crystal display device according to a second embodiment of the invention, as shown in FIG. 6, the first optical element OD1 includes a first polarizer plate 51, a first retardation plate RF1 which is disposed between the first polarizer plate 51 and the liquid crystal display panel LPN, and a second retardation plate RF2 which is disposed between the first retardation plate RF1 and the liquid crystal display panel LPN. The structure of the first optical element OD1 is the same as in the first embodiment, so a detailed description is omitted here.

The second optical element OD2 includes a second polarizer plate 61, a third retardation plate RF3 which is disposed between the second polarizer plate 61 and the liquid crystal display panel LPN, a fourth retardation plate RF4 which is disposed between the third retardation plate RF3 and the liquid crystal display panel LPN, and a fifth retardation plate RF5 which is disposed between the fourth retardation plate RF4 and the liquid crystal display panel LPN. The same components as in the first embodiment are applicable to the second polarizer plate 61 and third retardation plate RF3.

The fourth retardation plate RF4 that is applied in the second embodiment is a uniaxial retardation plate and has an Nz coefficient of 1.0. The fourth retardation plate RF4 is a so-called ¼ wavelength plate which imparts a phase difference of ¼ wavelength between light rays of a predetermined wavelength which pass through the fast axis and slow axis. The fifth retardation plate RF5, which is applicable as an optimal one to be combined with the fourth retardation plate RF4, should have a refractive index anisotropy of nx≅ny>nz (so-called a negative C-plate) where nx and ny are refractive indices in mutually perpendicular directions in the plane of the fifth retardation plate RF5, and nz is a refractive index in the normal direction. In the fifth retardation plate RF5, the in-plane retardation Ro, which is defined by Ro=(nx−ny)×d (d is a thickness of the fifth retardation plate in the normal direction), is substantially zero. The fifth retardation plate RF5 has a normal-directional retardation Rth, which is defined by Rth=[(nx−ny)/2−nz]×d (d is a thickness of the fifth retardation plate in the normal direction). The fifth retardation plate RF5 can be formed of a high polymer film or an evaporation deposition film. It is desirable that the fifth retardation plate RF5 have the normal-directional retardation Rth of 150 nm or less.

According to the second embodiment in which the uniaxial fourth retardation plate RF4 and the fifth retardation plate RF5 are combined, it is possible to obtain viewing angle characteristics, which are equal to or higher than the viewing angle characteristics in the case where the fourth retardation plate RF4 with the Nz coefficient in the range of 1.5 to 2.0 is applied in the first embodiment. By optimizing the normal-directional retardation of the fifth retardation plate RF5, the contrast ratio of 10:1 is obtained in the range of viewing angles of up to 80° in all the right-and-left and up-and-down directions of the screen, and a sufficiently wide viewing angle can be obtained.

Like the first embodiment, the viewing angle can further be increased by combining the second retardation plate RF2 having the range of the mean tilt angle of liquid crystal molecules, which is greater than 28°, in the structure of the above-described second embodiment.

According to the structure of the second embodiment, there is provided a liquid crystal display device which can improve the contrast, increase the viewing angle, and have a good display quality.

In the above-described first and second embodiments, the uniaxial retardation plates with the Nz coefficient of 1.0 (nx≠ny=nz) are applied as the first retardation plate RF1 and third retardation plate RF3. Retardation plates, which have the function of converting linearly polarized light emerging from the polarizer plate to a desired polarization state in corporation with the second retardation plate RF2 and fourth retardation plate RF4, can be selected as the first retardation plate RF1 and third retardation plate RF3.

In the first embodiment and second embodiment, in the liquid crystal display panel LPN, the director of liquid crystal molecules is set at 45° with respect to a reference direction which is the horizontal direction of the screen. In this case, the angle between the director of liquid crystal molecules and the X axis is set at 225°. On the basis of the results of studies shown in FIG. 4A to FIG. 4E, when the counterclockwise direction to the reference direction is a positive direction and the clockwise direction to the reference direction is a negative direction, the director of liquid crystal molecules is set in the range of ±20° with the center direction being set at 225° (i.e. in the range of 45°±20°). Thereby, the contrast ratio of 10:1 was obtained in the range of viewing angles of 60° or more in all the right-and-left and up-and-down directions of the screen.

At this time, the second retardation plate RF2 and fourth retardation plate RF4 are disposed such that their slow axes are substantially parallel to the director of liquid crystal molecules.

In addition, in the above-described first embodiment and second embodiment, the second retardation plate RF2 is disposed such that the alignment direction of liquid crystal molecules of the second retardation plate RF2 is substantially parallel to the director of the liquid crystal molecules.

### EXAMPLE 1

Next, a description is given of an example of the structure of the liquid crystal display device according to the first embodiment, in which the display mode is a normally white mode. The liquid crystal display device with this structure is designed, for example, as will be described below.

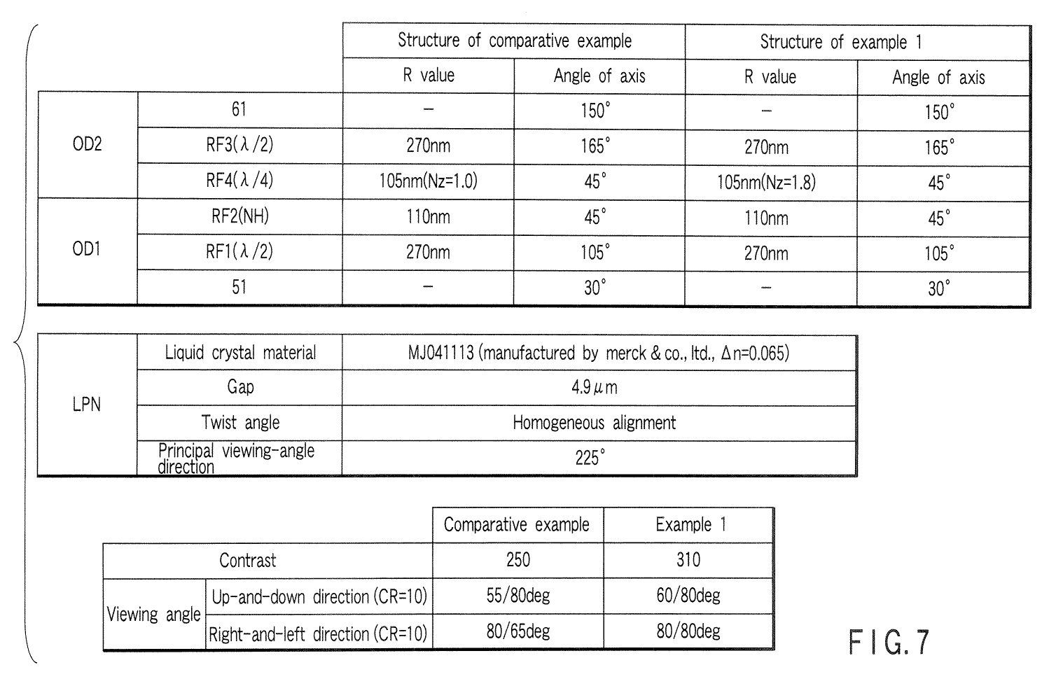

As shown in FIG. 7, as regards the liquid crystal display panel LPN, the liquid crystal layer LQ is composed of a liquid crystal composition including homogeneously aligned liquid crystal molecules 40. For example, MJ041113 (manufactured by Merck & Co., Ltd., Δn=0.065) was applied as the liquid crystal composition. At this time, the director (the major axis direction of liquid crystal molecules) 40D of liquid crystal molecules 40 was set at 225° to the X axis. In addition, the gap of the transmissive part in the liquid crystal layer LQ was set at 4.9 μm.

In order to cancel birefringence due to liquid crystal molecules 40, the slow axis D2 of the second retardation plate RF2 (i.e. the alignment direction of liquid crystal molecules of the second retardation plate RF2) of the first optical element OD1, which is to be disposed on the outer surface of the array substrate AR, is set in a direction (45° azimuth) that is parallel to the director. The in-plane retardation (R value) of the second retardation plate RF2 is set at, e.g. 110 nm. Then, the slow axis D1 of the first retardation plate (λ/2 plate) RF1 is set in a direction (105° azimuth) that intersects with the slow axis of the second retardation plate RF2 at an angle of 60°. The in-plane retardation (R value) of the first retardation plate RF1 is set at, e.g. 270 nm. Subsequently, the absorption axis A1 of the first polarizer plate 51 is set at 30° azimuth.

On the other hand, the slow axis D4 of the fourth retardation plate (λ/4 plate) RF4 of the second optical element OD2, which is to be disposed on the outer surface of the counter-substrate CT, is set in a direction (45° azimuth) that is parallel to the director. The in-plane retardation (R value) of the fourth retardation plate RF4 is set at, e.g. 105 nm. Then, the slow axis D3 of the third retardation plate (λ/2 plate) RF3 is set in a direction (165° azimuth) that intersects with the slow axis of the fourth retardation plate RF4 at an angle of 60°. The in-plane retardation (R value) of the third retardation plate RF3 is set at, e.g. 270 nm. Subsequently, the absorption axis A2 of the second polarizer plate 61 is set at 150° azimuth.

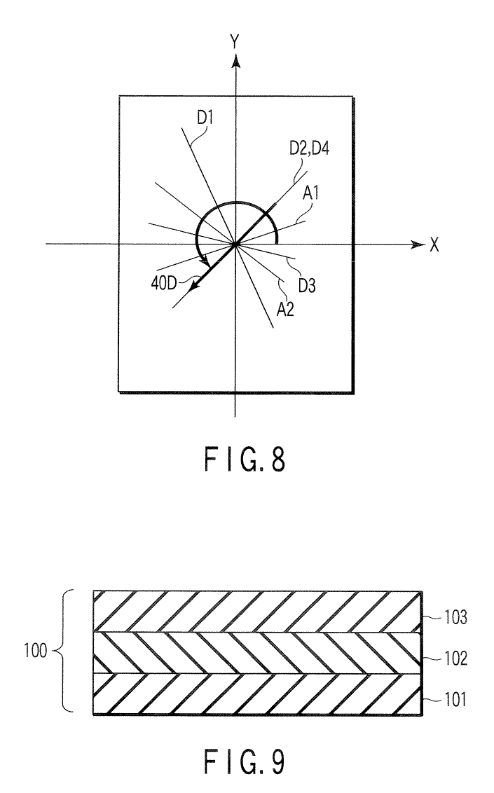

The above-described azimuth directions of the slow axes of the retardation plates and the azimuth directions of the absorption axes of the polarizer plates are defined by angles to the X axis, as shown in FIG. 8.

An NH film (manufactured by Nippon Oil Corporation) was applied as the second retardation plate RF2. ZEONOR films (manufactured by OPTES Inc.) were applied as the first retardation plate RF1 and third retardation plate RF3, and their Nz coefficient were 1.0. A ZEONOR film (manufactured by OPTES Inc.) was applied as the fourth retardation plate RF4, and its Nz coefficient was 1.8.

According to Example 1, it was confirmed that when transmissive display was effected by making use of the transmissive part, the contrast in the normal direction to the screen was 310. In addition, when the viewing angle dependency of the contrast ratio was simulated, it was confirmed that high-contrast regions were enlarged in substantially all directions and the decrease in contrast ratio was improved, in particular, in the up-and-down and right-and-left directions on the screen.

As a comparative example, a liquid crystal display device having the same structure as the device of Example 1, except that the Nz coefficient of the fourth retardation plate is set at 1.0, was simulated in the same manner. When transmissive display was effected by making use of the transmissive part, the contrast in the normal direction to the screen was 250. The contrast ratio of 10:1 was obtained in the upper part of the screen in the range of viewing angles of less than 60°.

### EXAMPLE 2

Next, a description is given of an example of the structure of the liquid crystal display device according to the second embodiment, in which the display mode is a normally white mode. The liquid crystal display device with this structure is designed, for example, as will be described below.

The structure of Example 2 is basically the same as that of Example 1 shown in FIG. 7. A VAC film (manufactured by Sumitomo Chemical Co., Ltd.) was applied as the fifth retardation plate RFS. The in-plane retardation of the fifth retardation plate RFS was Ro≅0 nm, and the normal-directional retardation of the fifth retardation plate RF5 was Rth=80 nm. A ZEONOR film (manufactured by OPTES Inc.) was applied as the fourth retardation plate RF4, and its Nz coefficient was 1.0.

According to Example 2, the same performance as in Example 1 was obtained. It was confirmed that when transmissive display was effected by making use of the transmissive part, the contrast in the normal direction to the screen was 340. In addition, when the viewing angle dependency of the contrast ratio was simulated, it was confirmed that high-contrast regions were enlarged in substantially all directions and the decrease in contrast ratio was improved, in particular, in the up-and-down and right-and-left directions on the screen.

In the above-described Examples 1 and 2, ZEONOR films that are uniaxial retardation plates were adopted as the first retardation plate, third retardation plate and fourth retardation plate. Alternatively, similar uniaxial retardation plates or biaxial retardation plates can be adopted, as needed, in accordance with the required performance or retardation to be compensated. As regards the second retardation plate (liquid crystal film), too, not only the NH film but also another kind of retardation plate having the viewing angle increasing function can be adopted as needed. Similarly, another kind of retardation plate can be adopted as the fifth retardation plate, as needed.

As has been described above, according to the present embodiment, there is provided a liquid crystal display device which can increase the viewing angle, suppress grey level inversion and have a good display quality.

The present invention is not limited directly to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

For example, in the embodiments, the switching elements W are composed of N-channel thin-film transistors. Alternatively, the switching elements W may have other structures if similar driving signals can be generated.

In the first and second embodiments, similar advantageous effects can be obtained even if the first optical element OD1 is disposed on the counter-substrate-side outer surface of the liquid crystal display panel LPN and the second optical element OD2 is disposed on the array-substrate-side outer surface of the liquid crystal display panel LPN.

At least one of the combination of the first polarizer plate 51 and first retardation plate RF1 of the first optical element OD1 and the combination of the second polarizer plate 61 and third retardation plate RF3 of the second optical element OD2 may be composed of an optical element 100, as shown in FIG. 9. The optical element 100 comprises a support layer 101, a polarizer layer 102 which is disposed on the support layer 101, and a retardation layer 103 which is disposed on the polarizer layer 102, is formed of a cycloolefin polymer and imparts a phase difference of ½ wavelength between light rays of a predetermined wavelength, which pass through the fast axis and slow axis thereof. The support layer 101 may be formed of triacetate cellulose (TAC). The polarizer layer 102 may be formed of polyvinyl alcohol (PVA) that is dyed. By applying the optical element 100, the number of components of each of the first optical element OD1 and second optical element OD2 can be reduced and the reduction in thickness and cost can be realized.

What is claimed is:

1. A liquid crystal display device comprising:
a liquid crystal display panel which is configured such that a liquid crystal layer including homogeneously aligned liquid crystal molecules is held between a first substrate and a second substrate which are disposed to be opposed to each other;
a first optical element which is provided on one of outer surfaces of the liquid crystal display panel and includes a first polarizer plate, a first retardation plate which is disposed between the first polarizer plate and the liquid crystal display panel and imparts a phase difference of ½ wavelength between light rays of a predetermined wavelength which pass through a fast axis and a slow axis of the first retardation plate, and a second retardation plate which is disposed between the first retardation plate and the liquid crystal display panel and imparts a phase difference of ¼ wavelength between light rays of a predetermined wavelength which pass through a fast axis and a slow axis of the second retardation plate, and the second retardation plate being formed such that nematic liquid crystal molecules are solidified in a state in which the nematic liquid crystal molecules are hybrid-aligned in a normal direction; and
a second optical element which is provided on the other outer surface of the liquid crystal display panel and includes a second polarizer plate, a third retardation plate which is disposed between the second polarizer plate and the liquid crystal display panel and imparts a phase difference of ½ wavelength between light rays of a predetermined wavelength which pass through a fast axis and a slow axis of the third retardation plate, and a fourth retardation plate which is disposed between the third retardation plate and the liquid crystal display panel and imparts a phase difference of ¼ wavelength between light rays of a predetermined wavelength which pass through a fast axis and a slow axis of the fourth retardation plate, wherein the fourth retardation plate has an Nz coefficient in a range of 1.5 to 2.0, which is defined by Nz=(nx−nz)/(nx−ny), where nx and ny are refractive indices in mutually perpendicular directions in a plane of the fourth retardation plate, and nz is a refractive index in a normal direction of the fourth retardation plate.

2. A liquid crystal display device comprising:
a liquid crystal display panel which is configured such that a liquid crystal layer including homogeneously aligned liquid crystal molecules is held between a first substrate and a second substrate which are disposed to be opposed to each other;
a first optical element which is provided on one of outer surfaces of the liquid crystal display panel and includes a first polarizer plate, a first retardation plate which is disposed between the first polarizer plate and the liquid crystal display panel and imparts a phase difference of ½ wavelength between light rays of a predetermined wavelength which pass through a fast axis and a slow axis of the first retardation plate, and a second retardation plate which is disposed between the first retardation plate and the liquid crystal display panel and imparts a phase difference of ¼ wavelength between light rays of a predetermined wavelength which pass through a fast axis and a slow axis of the second retardation plate, and the second retardation plate being formed such that nematic liquid crystal molecules are solidified in a state in which the nematic liquid crystal molecules are hybrid-aligned in a normal direction; and
a second optical element which is provided on the other outer surface of the liquid crystal display panel and includes a second polarizer plate, a third retardation plate which is disposed between the second polarizer plate and the liquid crystal display panel and imparts a phase difference of ½ wavelength between light rays of a predetermined wavelength which pass through a fast axis and a slow axis of the third retardation plate, a uniaxial fourth retardation plate which is disposed between the third retardation plate and the liquid crystal display panel and imparts a phase difference of ¼ wavelength between light rays of a predetermined wavelength which pass through a fast axis and a slow axis of the fourth retardation plate, and a fifth retardation plate which is disposed between the fourth retardation plate and the liquid crystal display panel,
wherein the fifth retardation plate has a refractive index anisotropy of nx≅ny>nz, where nx and ny are refractive indices in mutually perpendicular directions in a plane of the fifth retardation plate, and nz is a refractive index in a normal direction of the fifth retardation plate.

3. The liquid crystal display device according to claim 1, wherein a mean tilt angle of the liquid crystal molecules in the second retardation plate is set in a range of greater than 28°.

4. The liquid crystal display device according to claim 2, wherein a mean tilt angle of the liquid crystal molecules in the second retardation plate is set in a range of greater than 28°.

5. The liquid crystal display device according to claim 2, wherein the fifth retardation plate meets conditions of Ro≅0 nm and Rth≦150 nm, where d is a thickness of the fifth retardation plate in the normal direction, Ro is an in-plane retardation, which is Ro=(nx−ny)×d, and Rth is a normal-directional retardation, which is Rth=[(nx−ny)/2−nz]×d.
